(19) United States
(12) Patent Application Publication
(10) Pub. No.: US 2024/0098693 A1
(43) Pub. Date: Mar. 21, 2024

(54) COMMUNICATION METHOD AND APPARATUS, USER EQUIPMENT, NETWORK DEVICE AND STORAGE MEDIUM

(71) Applicant: Beijing Xiaomi Mobile Software Co., Ltd., Beijing (CN)

(72) Inventor: Rao SHI, Beijing (CN)

(21) Appl. No.: 18/263,066

(22) PCT Filed: Jan. 28, 2021
(86) PCT No.: PCT/CN2021/074218

§ 371 Date: Jul. 26, 2023

(51) Int. Cl. H04W 68/02; H04W 72/1273; H04W 76/28

(52) U.S. Cl. CPC H04W 68/02; H04W 72/1273; H04W 76/28

(57) ABSTRACT

A communication method includes: responding to a paging occasion (PO) in response to being unable to monitor a paging early indication (PEI) in a non-connected state.

### BACKGROUND

For UE in an idle/inactive state, a network searches for the UE through a paging mechanism. When the network has a downlink message or data that needs to be sent, the UE initiates radio resource control (RRC), connection establishment, and connection recovery procedures in a paging mode to return to an RRC connected state again. In addition, paging may also be used to notify UE in all states under network coverage to receive system message updates through short messages, as well as to notify an earthquake and tsunami warning system (ETWS) and a commercial mobile alert system (CMAS), and other warning information.

### SUMMARY

According to a first aspect of the disclosure, a communication method is provided and performed by UE, and includes:

responding to a PO in response to being unable to monitor a PEI in a non-connected state.

According to a second aspect of the disclosure, a communication method is provided and performed by a network device, and includes:

sending indication information to UE, where the indication information is used for indicating a response behavior to a PO in a scenario where the UE in a non-connected state is unable to monitor a PEI.

According to a third aspect of the disclosure, a user equipment is provided, and includes a processor, a transceiver, a memory and an executable program stored on the memory and able to be run by the processor, and the processor, when runs the executable program, executes steps of the communication method described in the first aspect.

According to a fourth aspect of the disclosure, a network device is provided, and includes a processor, a transceiver, a memory and an executable program stored on the memory and able to be run by the processor, and the processor, when runs the executable program, executes steps of the communication method described in the second aspect.

According to a fifth aspect of the disclosure, a storage medium is provided, and stores an executable program, and the executable program, when executed by a processor, implements the steps of the communication method described in the first aspect or the second aspect.

### BRIEF DESCRIPTION OF THE DRAWINGS

Accompanying drawings here are incorporated into and form part of the specification, show examples that comply with the disclosure and are used for explaining principles of the examples of the disclosure together with the specification.

FIG. 1 is a schematic structural diagram of a wireless communication system shown according to an example.

FIG. 2 is a schematic flow diagram of a communication method shown according to an example.

FIG. 3 is a schematic diagram of a corresponding relation of a PEI and a PO shown according to an example.

FIG. 4 is a schematic flow diagram of a communication method shown according to an example.

FIG. 5 is a schematic flow diagram of a communication method shown according to an example.

FIG. 6 is a schematic flow diagram of a communication method shown according to an example.

FIG. 7 is a schematic structural diagram of a composition of a communication apparatus shown according to an example.

FIG. 8 is a schematic structural diagram of a composition of a communication apparatus shown according to an example.

FIG. 9 is a schematic structural diagram of a composition of user equipment shown according to an example.

### DETAILED DESCRIPTION

Examples are illustrated in detail here, instances of which are shown in the accompanying drawings. When the descriptions below relate to the accompanying drawings, the same numbers in different accompanying drawings indicate the same or similar elements unless otherwise indicated. The implementations described in the following examples do not represent all implementations consistent with the examples of the disclosure. On the contrary, they are merely instances of apparatuses and methods that are consistent with some aspects of the examples of the disclosure as detailed in the attached claims.

Terms used in the examples of the disclosure are just for the purpose of describing specific examples and are not aimed at limiting the examples of the disclosure. Words “one”, “said” and “the” of singular forms used in the examples of the disclosure and the appended claims are also aimed at including plural forms, unless the context clearly shows other meanings. It shall also be understood that terms “and/or” used in the disclosure refer to and include any or all possible combinations of one or a plurality of relevant listed items.

It needs to be understood that although terms of first, second, third, etc. may be adopted to describe various pieces of information in the examples of the disclosure, the information is not limited to these terms. The terms are just used to distinguish the same type of information from one another. For example, under the condition of not departing from the scope of the examples of the disclosure, first information may also be called second information, and similarly, the second information may also be called the first information. Depending on the context, for example, the word “if” used here may be explained as “at the time of” or “when” or “in response to determining”

The disclosure relates to a communication method and apparatus, user equipment (UE), network device and storage medium.

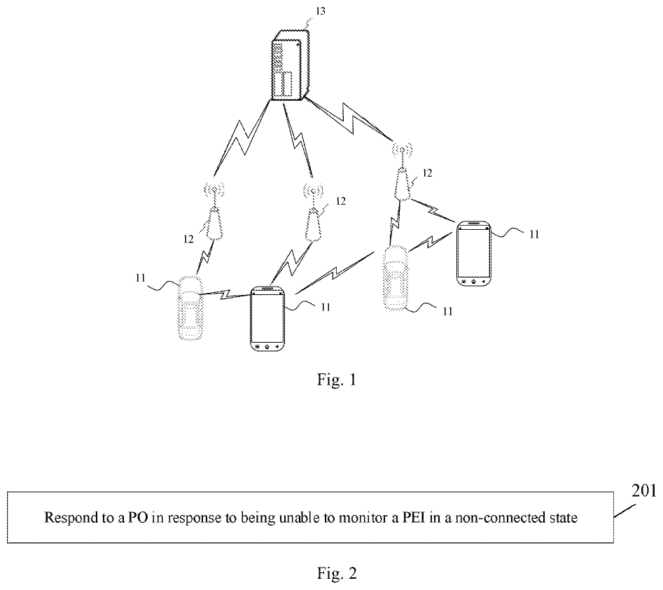

Please refer to FIG. 1, FIG. 1 shows a schematic structural diagram of a wireless communication system provided by an example of the disclosure. As shown in FIG. 1, the wireless communication system is a communication system based on a cellular mobile communication technology. The wireless communication system may include a plurality of terminals 11 and a plurality of base stations 12.

The terminals 11 may refer to a device providing voice and/or data connectivity for a user. The terminals 11 may communicate with one or more core networks via a radio access network (RAN), and the terminals 11 may be Internet of Things terminals, such as sensor devices and mobile phones (or called “cellular” phones), and computers with the Internet of Things terminals, for example, may be stationary, portable, pocket, handheld, computer built-in, or vehicle-mounted apparatuses. For example, it may be a station (STA), a subscriber unit, a subscriber station, a mobile station, a mobile, a remote station, an access point, a remote terminal, an access terminal, a user terminal, a user agent, a user device or user equipment. Or, the terminals 11 may also be devices of an unmanned aerial vehicle. Or, the terminals 11 may also be vehicle-mounted devices, for example, may be trip computers with a wireless communication function or wireless communication devices externally connected with the trip computers. Or, the terminals 11 may also be road-side devices, for example, may be street lamps, signal lamps or other road-side devices with a wireless communication function.

The base stations 12 may be network side devices in the wireless communication system. The wireless communication system may be a 4th generation mobile communication (4G) system, also known as a long term evolution (LTE) system; or the wireless communication system may also be a 5G system, also known as a new radio (NR) system or a 5G NR system. Or, the wireless communication system may also be an any-generation system. An access network in the 5G system may be called a new generation-radio access network (NG-RAN), or an MTC system.

The base stations 12 may be evolution bae stations (eNBs) adopted in the 4G system. Or, the base stations 12 may also be base stations (gNBs) adopting a centralized distributed architecture in the 5G system. When the base stations 12 adopt the centralized distributed architecture, the base stations generally include a central unit (CU) and at least two distributed units (DUs). Protocol stacks of a packet data convergence protocol (PDCP) layer, a radio link control (RLC) layer and a media access control (MAC) layer are set in the central unit; and a protocol stack of a physical (PHY) layer is set in distributed unit. Specific implementations of the base stations 12 are not limited by the examples of the disclosure.

A wireless connection may be built between base stations 12 and the terminals 11 through wireless radios. In different implementations, the wireless radios are wireless radios based on the 4th generation mobile communication network technology (4G) standard; or the wireless radios are wireless radios based on the 5th generation mobile communication network technology (5G) standard, for example, the wireless radios are new radios; or the wireless radios may also be wireless radios based on the next-generation mobile communication network technology standard of the 5G.

In some examples, an end to end (E2E) connection may also be built among the terminals 11, for example, vehicle to vehicle (V2V) communication, vehicle to infrastructure (V2I) communication and vehicle to pedestrian (V2P) communication and other scenarios in vehicle to everything (V2X).

In some examples, the above wireless communication system may further include a network management device 13.

The plurality of base stations 12 are respectively connected with the network management device 13, the network management device 13 may be a core network device in the wireless communication system, for example, the network management device 13 may be a mobility management entity (MME) in an evolved packet core (EPC). Or the network management device may also be other core network devices, such as a serving gateway (SGW), a public data network gateway (PGW), a policy and charging rules function (PCRF) unit or a home subscriber server (HSS). For an implementation form of the network management device 13, the examples of the disclosure do not limit it.

Executive bodies involved in the examples of the disclosure include, but are not limited to user equipment (UE) in a cell mobile communication system, a base station of a cell mobile communication, etc.

UE calculate a paging occasion (PO) by a formula, based on paging configuration messages in an SIB1 broadcasted by a system, a UE_ID and UE_specific periods, the UE monitors paging at the PO, but delivery of paging messages does not necessarily exist within each PO, and continuous monitoring of the PO will lead to wasted power consumption, so that an NR considers to introduce paging early indication (PEI) to indicate whether the UE needs to perform a paging procedure by judging whether there is a paging message, so as to achieve a purpose of power saving.

Since PEI signals are introduced before the PO, correspondingly, a large number of PEI monitoring occasions are also introduced on a network side, which is likely to lead to overlapping of the PEI signals and other monitoring occasions in the idle state, for example, other public search spaces are already configured in a PEI monitoring location, and have a higher priority than a search space corresponding to the PEI, and UE cannot monitor the PEI at this location.

In view of this, examples of the disclosure provide a communication method and apparatus, user equipment, a network device and a storage medium.

FIG. 2 is a schematic flow diagram of a communication method shown according to an example. As shown in FIG. 2, the communication method of the example of the disclosure is applied to UE, and includes following processing steps:

step 201, responding to a PO is performed in response to being unable to monitor a PEI in a non-connected state.

In the example of the disclosure, mainly, when the UE is in the non-connected state, the UE performs monitoring merely when the paging occasion arrives. When the PEI in the system misses, the UE needs to respond to the corresponding PO according to a relevant indication of a network device, or directly monitors the PO corresponding to the missed PEI after not receiving the relevant indication information of the network device.

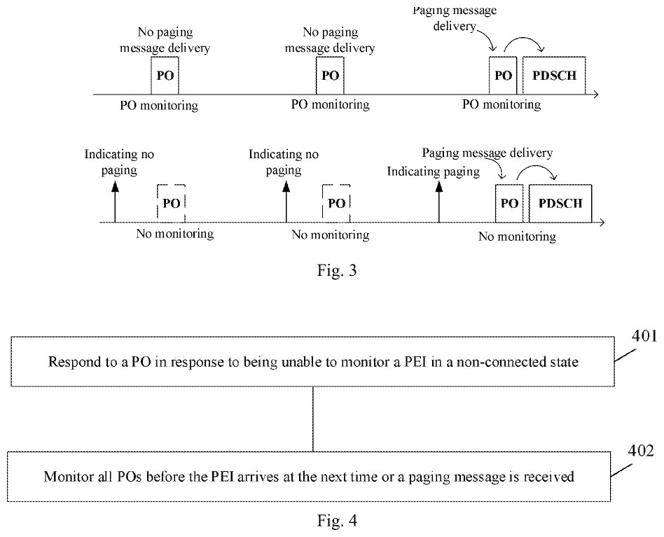

FIG. 3 is a schematic diagram of a corresponding relation of a PEI and a PO shown according to an example. As shown in FIG. 3, an overall process of one-time paging consists of synchronization signal and PBCH block (SSB) synchronization, PO monitoring paging control information, PDSCH receiving paging messages, and a light sleep state between processes, and after the PEI is introduced, the UE may omit most of power consumption in the above process when there is no paging, which may bring significant gains.

However, the monitoring occasion of the PO in an idle/inactive state is relatively intensive. As shown in Table 1, the network device can configure each frame of SFN to be a paging frame PF (for example, oneT) through nAndPagingFrameOffset and Ns parameters, and each PF can be configured with four POs (for example, Ns=4). Table 1 is a paging parameter condiguartion

| PCCH-Config:: = | SEQUENCE{ |
|---|---|
| defaultPagingCycle | PagingCycle, |
| nAndPagingFrameOffset | CHOICE{ |
| oneT | NULL, |
| halfT | INTERGER(0...1), |
| quarterT | INTERGER(0...3), |
| oneEighthT | INTERGER(0...7), |
| oneSixteenthT | INTERGER (0...15) |
| }, | |
| ns | ENUMERATED(four,two,one), |

By introducing PEI signals before each PO, a large number of PEI monitoring occasions are introduced on the network side, so that there may be a scenario where the PEI monitoring occasions overlap with other monitoring occasions in an idle state, resulting in a situation where the UE is unable to perform PEI monitoring at this resource overlapping location.

Aiming at the above scenario where the PEI overlaps with other resources, the example of the disclosure indicates the PO monitoring when the UE misses the PEI. Even if the PEI is missed, the PO corresponding to the missed PEI may be monitored, so that the UE may be paged.

Specifically, the UE receives the indication information sent by the network device, and the indication information is used for indicating a response behavior to the PO in a scenario where the PEI is unable to be monitored. The UE may receive the indication information sent by the network device through RRC signaling sent by the network side, at the moment, the network device performs a monitoring indication of the PO on the UE missing the PEI by carrying the indication information in the RRC signaling, so as to indicate the UE how to monitor the PO.

Or, as an implementation, the UE may also receive the indication information sent by the network device through a system message sent by the network side, at the moment, the network device indicates the UE in a broadcasting mode by carrying the indication information in the system message, so that the UE missing the PEI may also monitor the PO.

After receiving the indication information sent by the network device, the UE monitors the PO corresponding to the PEI based on a discontinuous reception (DRX) when it is determined that the indication information indicates a first value. When it is determined that the indication information indicates a second value, the PO corresponding to the PEI is not monitored. In the example of the disclosure, the discontinuous reception may also be an extended discontinuous reception (eDRX). For example, when the indication information indicates true, the UE monitors the PO corresponding to the missed PEI, and if the indication information indicates false, the UE does not monitor the PO corresponding to the missed PEI. For example, a 1-bit character in the indication information indicates true or false, so that the UE monitors the PO corresponding to the missed PEI, when an indicator in the indication information is 1, it indicates true, when the indicator in the indication information is 0, it indicates false, or when the indicator in the indication information is 0, it indicates true, and when the indicator in the indication information is 1, it indicates false. Here, the first value may be 0 or 1, and correspondingly, the second value may be 1 or 0. Those skilled in the art shall understand that any value represented by more than 1-bit information may also select two values optionally to indicate the UE to monitor or not to monitor the PO.

When the network side does not send the above indication information, the UE does not receive the above indication information, and the PO corresponding to the missed PEI is directly monitored based on the DRX mode.

In the example of the disclosure, the UE monitoring the PO corresponding to the PEI includes: all POs corresponding to the PEI are monitored before the next PEI monitoring occasion arrives or a paging message is received.

The UE not monitoring the PO corresponding to the PEI includes:
the PO corresponding to the PEI is not monitored before the next PEI monitoring occasion arrives.

In the example of the disclosure, the UE being unable to monitor the PEI includes at least one of the followings:
the PEI monitoring occasion colliding with other searching spaces. At the moment, the UE needs to monitor the other searching spaces according to a monitoring priority, and PEI monitoring fails, or the PEI is unable to be received under interference of the other searching spaces.

The PEI monitoring occasion colliding with other physical downlink shared channels (PDSCHs). Similar to the above situation, when the PEI monitoring occasion collides with a PDSCH, the PDSCH has a higher priority than the PEI, other PDSCHs need to be monitored, and PEI monitoring fails, or, the PEI is unable to be received under interference of other PDSCHs.

The UE missing the PEI monitoring occasion; and
the UE failing to decode the PEI. The UE demodulates PEI information at a time frequency resource location corresponding to the PEI, but demodulation fails.

In the example of the disclosure, responding to the PO is performed based on the indication information in the RRC signaling when receiving the indication information both through the RRC signaling and the system message. In other words, a priority of the RRC signaling is higher than a priority of the system message.

FIG. 4 is a schematic flow diagram of a communication method shown according to an example. As shown in FIG. 4, the communication method of the example of the disclosure is applied to UE, and includes following processing steps:

step 401, responding to a PO is performed in response to being unable to monitor a PEI in a non-connected state.

When the UE is in the non-connected state, the UE performs monitoring merely when the paging occasion arrives, when the PEI in a system is missed, the UE needs to respond to the corresponding PO according to a relevant indication of a network device, or after relevant indication information of the network device is not received, the PO corresponding to the missed PEI is directly monitored.

In the example of the disclosure, the UE being unable to monitor the PEI includes at least one of the followings:
a PEI monitoring occasion colliding with other searching spaces. At the moment, the UE needs to monitor other searching spaces according to a monitoring priority, and PEI monitoring fails, or the PEI is unable to be received under interference of other searching spaces.

The PEI monitoring occasion colliding with other physical downlink shared channels (PDSCHs). Similar to the above situation, when the PEI monitoring occasion collides with a PDSCH, and the PDSCH has a higher priority than the PEI, the other PDSCHs need to be monitored, and PEI monitoring fails, or the PEI is unable to be received under interference of the other PDSCHs.

The UE missing the PEI monitoring occasion; and
the UE failing to decode the PEI. The UE demodulates PEI information at a time frequency resource location corresponding to the PEI, but demodulation fails.

In the example of the disclosure, when the network side does not send the above indication information, and the UE does not receive the indication information, the PO corresponding to the missed PEI is directly monitored based on the DRX mode.

In the example of the disclosure, responding to the PO is performed based on the indication information in the RRC signaling when receiving the indication information both through the RRC signaling and the system message. In other words, a priority of the RRC signaling is higher than a priority of the system message.

Step 402, all POs are monitored before the next PEI monitoring occasion arrives or the paging message is received.

In the example of the disclosure, after receiving the indication information sent by the network device, the UE monitors the PO corresponding to the PEI based on a discontinuous reception when it is determined that the indication information indicates a first value.

For example, when the indication information indicates true, the UE monitors the PO corresponding to the missed PEI. Here, the first value may be 0 or 1, and used for indicating true. Those skilled in the art shall understand that any value represented by more than 1-bit information may also select a value optionally to indicate the UE to perform the monitoring behavior of the PO.

Or, when the network side does not send the above indication information, and the UE does not receive the indication information, the PO corresponding to the missed PEI is monitored directly based on the DRX mode.

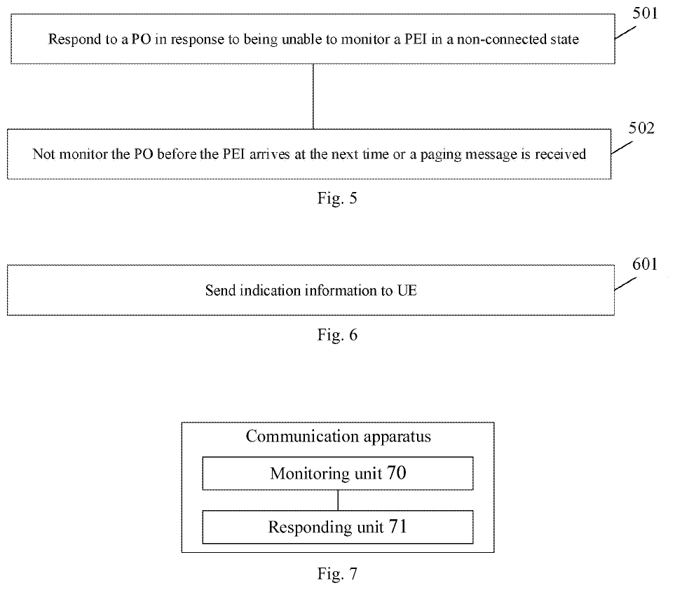

FIG. 5 is a schematic follow diagram of a communication method shown according to an example. As shown in FIG. 5, the communication method of the example of the disclosure is applied to UE, and includes following processing steps:
step 501, responding to a PO is performed in response to being unable to monitor a PEI in a non-connected state.

Here, a response behavior to the PO further includes not monitoring the PO corresponding to the PEI.

In the example of the disclosure, the UE being unable to monitor the PEI includes at least one of the followings:
a PEI monitoring occasion colliding with other searching spaces. At the moment, the UE needs to monitor other searching spaces according to a monitoring priority, and PEI monitoring fails, or the PEI is unable to be received under interference of other searching spaces.

The PEI monitoring occasion colliding with other physical downlink shared channels (PDSCHs). Similar to the above situation, when the PEI monitoring occasion collides with a PDSCH, and the PDSCH has a higher priority than the PEI, the other PDSCHs need to be monitored, and PEI monitoring fails, or the PEI is unable to be received under interference of the other PDSCHs.

The UE missing the PEI monitoring occasion; and
the UE failing to decode the PEI. The UE demodulates PEI information at a time frequency resource location corresponding to the PEI, but demodulation fails.

In the example of the disclosure, responding to the PO is performed based on the indication information in the RRC signaling when receiving the indication information both through the RRC signaling and the system message. In other words, a priority of the RRC signaling is higher than a priority of the system message.

Step 502, the PO is not monitored before the next PEI monitoring occasion arrives or the paging message is received.

After receiving the indication information sent by the network device, the UE does not monitor the PO corresponding to the PEI when it is determined that the indication information indicates a second value. In the example of the disclosure, the discontinuous reception may further be an eDRX. For example, when the indication information indicates false, the UE does not monitor the PO corresponding to the missed PEI. For example, a 1-bit character in the indication information indicates false, so as to indicate the UE not to monitor the PO corresponding to the missed PEI any more, and when an indicator in the indication information is 1 or 0, it indicates false. Here, the second value may be 0 or 1. Those skilled in the art shall understand that any value represented by more than 1-bit information may also select two values optionally to indicate a behavior that the UE does not monitor the PO.

FIG. 6 is a schematic flow diagram of a communication shown according to an example. As shown in FIG. 6, the communication method of the example of the disclosure is applied to a network device, and the communication method of the example of the disclosure includes following processing steps:
step 601, indication information is sent to UE.

The indication information is used for indicating a response behavior to a PO in a scenario where the UE in the non-connected state is unable to monitor a PEI.

Specifically, a network device sends the indication information to the UE through an RRC signaling; and/or
the indication information is sent to the UE through a system message. The network device here includes a base station, a relay station, a remote radio unit, etc.

In the example of the disclosure, a response behavior to the PO includes:
monitoring all POs before the next PEI monitoring occasion arrives or a paging message is received; or
not monitoring the PO before the next PEI monitoring occasion arrives.

In the example of the disclosure, the UE being unable to monitor the PEI includes at least one of the followings:
a PEI monitoring occasion colliding with other searching spaces. At the moment, the UE needs to monitor other searching spaces according to a monitoring priority, and PEI monitoring fails, or the PEI is unable to be received under interference of other searching spaces.

The PEI monitoring occasion colliding with other physical downlink shared channels (PDSCHs). Similar to the above situation, when the PEI monitoring occasion collides with a PDSCH, and the PDSCH has a higher priority than the PEI, the other PDSCHs need to be monitored, and PEI monitoring fails, or the PEI is unable to be received under interference of the other PDSCHs.

The UE missing the PEI monitoring occasion; and
the UE failing to decode the PEI. The UE demodulates PEI information at a time frequency resource location corresponding to the PEI, but demodulation fails.

The communication method of the disclosure is further illustrated in detail below through instances.

### Example 1

In the instance, a PEI collides with other searching spaces.

A network device uses a downlink control information (DCI) format 1_x/2_6 to carry the PEI, and considers that when PEI resources collide with a public searching space channel signaling system (CSS) used for PDCCH monitoring and a PDSCH, the UE is unable to monitor the PEI due to different resource priorities.

The network device is configured with one-bit monitoring indication information to indicate the UE to monitor the PO in a case of missing the PEI, and the network device may send the indication information to the independent UE in an RRCEarlyDateComplete message and/or RRCconnectionRelease message, or send the indication information to all UE in a cell through a broadcasting message such as a paging configuration SIB1.

When the UE is unable to monitor the above PEI, monitoring of the PO is performed according to an indication content corresponding to an indication parameter carried in the indication information, for example, when the indication parameter is 1, it shows that the UE monitors the corresponding PO, and the UE monitors all POs corresponding to the PEI before the next PEI monitoring occasion arrives or the paging message is received. When the indication parameter is 0, it shows that the UE does not monitor the corresponding PO, and the UE does not monitor the PO corresponding to the PEI before the next PEI monitoring occasion arrives.

For the situation that the network device does not send the indication information, and at this time, when the UE is unable to monitor the above PEI, the corresponding PO is directly monitored.

### Example 2

The instance corresponds to UE missing a PEI monitoring occasion.

The UE performs monitoring according to a PEI configured by paging in an idle state, if cell reselection occurs in the UE, the UE is unable to monitor the PEI due to clock and bandwidth desynchrony between cells.

Corresponding to a situation of a 1-bit indication parameter configured by the network device, the network device may send the indication information to the independent UE in an RRCEarlyDateComplete message or RRCconnectionRelease message, or send the indication information to all UE in a cell through a broadcasting message such as a paging configuration SIB 1.

When the UE is unable to monitor the above PEI, a monitoring behavior of the PO is performed according to bit information corresponding to an indication parameter carried in the indication information, for example, the indication parameter is 1, the UE monitors the corresponding PO, the indication parameter is 0, and the UE does not monitor the corresponding PO. Or the indication parameter is 0, the UE monitors the corresponding PO, the indication parameter is 1, and the UE does not monitor the corresponding PO.

Corresponding to the situation that the network device does not send the indication information, and at this time, when the UE is unable to monitor the above PEI, the corresponding PO is directly monitored.

### Example 3

The instance corresponds to UE failing to decode a PEI.

When the UE monitors the PEI, the UE is unable to obtain PEI information due to some factors such as poor signal quality and decoding failures because of device problems.

Corresponding to a situation of a 1-bit monitoring indication parameter configured by the network device, the network device may send the indication information carrying a corresponding indication parameter to the independent UE in an RRCEarlyDateComplete message or RRCconnectionRelease message, or send the indication information to all UE in a cell through a broadcasting message such as a paging configuration SIB 1.

When the UE is unable to monitor the above PEI, a corresponding monitoring behavior of the PO is executed according to bit information of the monitoring indication parameter carried in the indication information, for example, the indication parameter is 1, the UE monitors the corresponding PO, the indication parameter is 0, and the UE does not monitor the corresponding PO. Or the indication parameter is 0, the UE monitors the corresponding PO, the indication parameter is 1, and the UE does not monitor the corresponding PO.

Corresponding to the situation that the network device does not send the indication information, and at this time, when the UE is unable to monitor the above PEI, the corresponding PO is directly monitored.

The communication method and configuration, the user equipment, the network device and the storage medium of the examples of the disclosure set the indication information for the UE, so as to indicate how the UE may still monitor the PO without the PEI when the PEI conflicts with other resources, so that the UE may still respond to the paging message in a case of missing the PEI, and the UE may not miss paging initiated by the network for the UE. The examples of the disclosure solve the problem in which PEI resources may still respond to paging at a network side when occupied by other resources that have a higher priority, thus improving network service capabilities, ensuring a paging success rate of the UE, and improving user experience.

FIG. 7 is a schematic structural diagram of a composition of a communication apparatus shown according to an example. As shown in FIG. 7, the communication apparatus of the example of the disclosure is applied to UE and includes:
a monitoring unit 70, configured to monitor a PEI; and
a responding unit 71, configured to respond to a PO in response to the UE in a non-connected state being unable to monitor the PEI.

As an implementation, on the basis of the communication apparatus shown in FIG. 7, the communication apparatus of the example of the disclosure further includes:
a receiving unit (not shown in FIG. 7), configured to receive indication information sent by a network device, where the indication information is used for indicating a response behavior to the PO in a scenario where the PEI is unable to be monitored.

As an implementation, the response behavior to the PO in the scenario where the PEI is unable to be monitored includes:
monitoring the PO corresponding to the PEI based on a discontinuous reception (DRX) in response to the indication information indicating a first value.

As an implementation, the response behavior to the PO in the scenario where the PEI is unable to be monitored includes:
not monitoring the PO corresponding to the PEI in response to the indication information indicating a second value.

As an implementation, the response behavior to the PO in the scenario where the PEI is unable to be monitored includes:

monitoring the PO corresponding to the PEI based on the DRX in response to not receiving the indication information.

As an implementation, monitoring the PO corresponding to the PEI includes:
all POs corresponding to the PEI are monitored before the next PEI monitoring occasion arrives or a paging message is received.

As an implementation, not monitoring the PO corresponding to the PEI includes:
the PO corresponding to the PEI is not monitored before the next PEI monitoring occasion arrives.

As an implementation, in the example of the disclosure, the UE being unable to monitor the PEI includes at least one of the followings:
a PEI monitoring occasion colliding with other searching spaces. At the moment, the UE needs to monitor other searching spaces according to a monitoring priority, and PEI monitoring fails, or the PEI is unable to be received under interference of other searching spaces.

The PEI monitoring occasion colliding with other physical downlink shared channels (PDSCHs). Similar to the above situation, when the PEI monitoring occasion collides with a PDSCH, and the PDSCH has a higher priority than the PEI, the other PDSCHs need to be monitored, and PEI monitoring fails, or the PEI is unable to be received under interference of the other PDSCHs.

The UE missing the PEI monitoring occasion; and
the UE failing to decode the PEI. The UE demodulates PEI information at a time frequency resource location corresponding to the PEI, but demodulation fails.

As an implementation, the receiving unit is further configured to:
receive the indication information through an RRC signaling; and/or
receive the indication information through a system message.

As an implementation, the responding unit 51 is further configured to:
respond to the PO based on the indication information in the RRC signaling when receiving the indication information both through the RRC signaling and the system message.

In an example, the monitoring unit 70, the responding unit 71, the receiving unit, etc. may be implemented by one or more central processing units (CPUs), graphics processing units (GPUs), base processors (BPs), application specific integrated circuits (ASICs), DSPs, programmable logic devices (PLDs), complex programmable logic devices (CPLDs), field-programmable gate arrays (FPGAs), general processors, controllers, micro controller units (MCUs), microprocessors, or other electronic elements, and may also be implemented in combination with one or more radio frequency (RF) antennas to be configured to execute steps of the communication method of the above examples.

In the example of the disclosure, specific modes of executing operations by each module and unit in the communication apparatus shown in FIG. 7 are already described in detail in the examples relevant to the method, which are not illustrated in detail here.

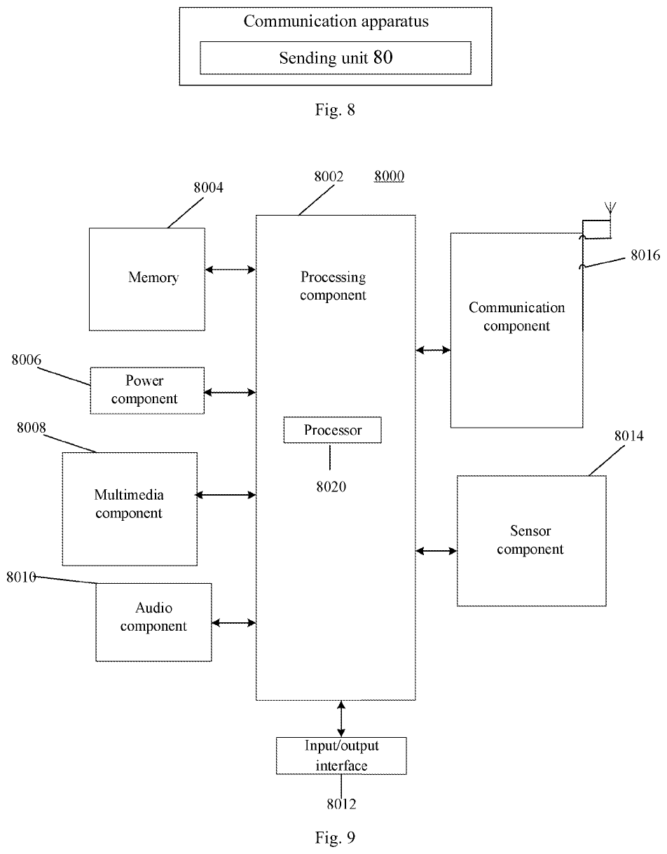

FIG. 8 is a schematic structural diagram of a composition of a communication apparatus shown according to an example. As shown in FIG. 8, the communication apparatus of the example of the disclosure is applied to a network device and includes:
a sending unit 80, configured to send indication information to UE, where the indication information is used for indicating a response behavior to a PO in a scenario where the UE in a non-connected state is unable to monitor a PEI.

As an implementation, the sending unit 80 is further configured to:
send the indication information to the UE through RRC signaling; and/or
send the indication information to the UE through a system message.

As an implementation, the response behavior to the PO includes:
monitoring all POs before the next PEI monitoring occasion arrives or a paging message is received; or
not monitoring the PO before the next PEI monitoring occasion arrives.

As an implementation, in the example of the disclosure, the UE being unable to monitor the PEI includes at least one of the followings:
a PEI monitoring occasion colliding with other searching spaces. At the moment, the UE needs to monitor other searching spaces according to a monitoring priority, and PEI monitoring fails, or the PEI is unable to be received under interference of other searching spaces.

The PEI monitoring occasion colliding with other physical downlink shared channels (PDSCHs). Similar to the above situation, when the PEI monitoring occasion collides with a PDSCH, and the PDSCH has a higher priority than the PEI, the other PDSCHs need to be monitored, and PEI monitoring fails, or the PEI is unable to be received under interference of the other PDSCHs.

The UE missing the PEI monitoring occasion; and
the UE failing to decode the PEI. The UE demodulates PEI information at a time frequency resource location corresponding to the PEI, but demodulation fails.

In an example, the sending unit 80, etc. may be implemented by one or more central processing units (CPUs), graphics processing units (GPUs), base processors (BPs), application specific integrated circuits (ASICs), DSPs, programmable logic devices (PLDs), complex programmable logic devices (CPLDs), field-programmable gate arrays (FPGAs), general processors, controllers, micro controller units (MCUs), microprocessors, or other electronic elements, and may also be implemented in combination with one or more radio frequency (RF) antennas to be configured to execute steps of the communication method of the above examples.

In the example of the disclosure, specific modes of executing operations by each module and unit in the communication apparatus shown in FIG. 8 are already described in detail in the examples relevant to the method, which are not illustrated in detail here.

FIG. 9 is a block diagram of user equipment 8000 shown according to an example. For example, the user equipment 8000 may be a mobile phone, a computer, a digital broadcasting user device, a messaging device, a game console, a tablet device, a medical device, a fitness device, a personal digital assistant, etc.

Referring to FIG. 9, the user equipment 8000 may include one or more of following components: a processing component 8002, a memory 8004, a power component 8006, a multimedia component 8008, an audio component 8010, an input/output (I/O) interface 8012, a sensor component 8014, and a communication component 8016.

The processing component 8002 typically controls the overall operation of the user equipment 8000, such as operation associated with display, telephone call, data communication, camera operation, and recording operation. The processing component 8002 may include one or more processors 8020 to execute instructions to complete all or part of the steps of the above method. In addition, the processing component 8002 may include one or more modules to facilitate interactions between the processing component 8002 and other components. For example, the processing component 8002 may include a multimedia module to facilitate the interaction between the multimedia component 8008 and the processing component 8002.

The memory 8004 is configured to store various types of data to support operation on the equipment 8000. Instances of such data include instructions for any application program or methods operating on the user equipment 8000, contact data, phone book data, messages, pictures, videos, etc. The memory 8004 may be implemented by any type of volatile or non-volatile storage devices or their combination, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or optical disc.

The power component 8006 provides power to the various components of the user equipment 8000. The power component 8006 may include a power management system, one or more power supplies, and other components associated with generating, managing, and distributing power for the user equipment 8000.

The multimedia component 8008 includes a screen providing an output interface between the user equipment 8000 and a user. In some examples, the screen may include a liquid crystal display (LCD) and a touch panel (TP). If the screen includes the touch panel, the screen may be implemented as a touch screen to receive input signals from the user. The touch panel includes one or more touch sensors to sense touch, slide, and gestures on the touch panel. The touch sensor may not only sense boundaries of a touch or slide action, but also detect the duration and pressure associated with the touch or slide action. In some examples, the multimedia component 8008 includes a front camera and/or a rear camera. When the user equipment 8000 is in an operation mode, such as a shooting mode or video mode, the front camera and/or the rear camera may receive external multimedia data. Each front camera and each rear camera may be a fixed optical lens system or have focal length and optical zoom capability.

The audio component 8010 is configured to output and/or input audio signals. For example, the audio component 8010 includes a microphone (MIC) that is configured to receive external audio signals when the user equipment 8000 is in an operation mode, such as a call mode, a recording mode, and a speech recognition mode. The received audio signals may be further stored in the memory 8004 or sent via the communication component 8016. In some examples, the audio component 8010 also includes a speaker for the output of the audio signals.

The I/O interface 8012 provides an interface between the processing component 8002 and a peripheral interface module, and the peripheral interface module may be a keyboard, a click wheel, buttons, etc. These buttons may include, but are not limited to a home button, a volume button, a start button, and a lock button.

The sensor component 8014 includes one or more sensors configured to provide a status assessment of all aspects of the user equipment 8000. For example, the sensor component 8014 may detect an on/off state of the equipment 8000, and relative positioning of the components, for example, the component is a display and a keypad of the user equipment 8000, and the sensor component 8014 may also detect the change in the position of the user equipment 8000 or one of the components of the user equipment 8000, presence or absence of contact between the user and the user equipment 8000, an orientation or acceleration/deceleration of the user equipment 8000 and a temperature change of the user equipment 8000. The sensor component 8014 may include a proximity sensor configured to detect presence of nearby objects without any physical contact. The sensor component 8014 may also include an optical sensor, such as a CMOS or CCD image sensors, configured to be used in imaging applications. In some examples, the sensor component 8014 may also include an acceleration sensor, a gyroscope sensor, a magnetic sensor, a pressure sensor or a temperature sensor.

The communication component 8016 is configured to facilitate wired or wireless communication between the user equipment 8000 and other devices. The user equipment 8000 may access a wireless network based on a communication standard, such as WiFi, 2G or 3G, or their combination. In an example, the communication component 8016 receives broadcast signals or broadcast-related information from an external broadcast management system via a broadcast channel. In an example, the communication component 8016 also includes a near-field communication (NFC) module to promote short-range communication. For example, the NFC module may be realized based on a radio frequency identification (RFID) technology, an infrared data association (IrDA) technology, an ultra wideband (UWB) technology, a Bluetooth (BT) technology and other technologies.

In an example, the user equipment 8000 may be implemented by one or more application specific integrated circuits (ASICs), digital signal processors (DSPs), digital signal processing devices (DSPDs), programmable logic devices (PLDs), field programmable gate array (FPGAs), controllers, microcontrollers, microprocessors, or other electronic components, configured to perform the above communication method.

In an example, a non-transient computer readable storage medium including instructions is also provided, such as a memory 8004 including the instructions, and the above instructions may be executed by the processor 8020 of the user equipment 8000 to complete the above communication method. For example, the non-transient computer readable storage medium may be an ROM, a random access memory (RAM), a CD-ROM, a magnetic tape, a floppy disk, an optical data storage device, etc.

In an example, a network device is further recorded, including a processor, a transceiver, a memory and an executable program stored on the memory and able to be run by the processor, and the processor, when runs the executable program, executes the steps of the communication method. The network device here includes a base station, a relay station, a remote radio unit, etc.

In an example, a storage medium is further recorded, on which an executable program is stored, and the executable program, when run by the processor, implements the steps of the communication method of the above examples.

After considering the specification and the practice of the disclosure disclosed here, those skilled in the art will easily think of other implementation solutions of the disclosure. The present application is intended to cover any variation, use or adaptation changes of the examples of the disclosure, these variation, use or adaptation changes follow general principles of the examples of the disclosure and include common knowledge or customary technical means in the technical field not disclosed in the disclosure. The specification and the examples are merely regarded as examples, and the true scope and spirit of the examples of the disclosure are indicated by the claims below.

It needs to be understood that the examples of the disclosure are not limited to a precise structure already described above and shown in the accompanying drawings and various modifications and changes may be performed without departing from the scope of the disclosure. The scope of the examples of the disclosure is limited merely by the appended claims.

In view of this, examples of the disclosure provide a communication method and apparatus, user equipment, a network device and a storage medium.

According to a first aspect of the disclosure, a communication method is provided and applied to UE, and includes:
responding to a PO in response to being unable to monitor a PEI in a non-connected state.

In an example, the method further includes:
receiving indication information sent by a network device, where the indication information is used for indicating a response behavior to the PO in a scenario where the PEI is unable to be monitored.

In an example, the response behavior to the PO in a scenario where the PEI is unable to be monitored includes:
monitoring the PO corresponding to the PEI based on a discontinuous reception (DRX) in response to the indication information indicating a first value.

In an example, the response behavior to the PO in a scenario where the PEI is unable to be monitored includes:
not monitoring the PO corresponding to the PEI in response to the indication information indicating a second value.

In an example, the response behavior to the PO in a scenario where the PEI is unable to be monitored includes:
monitoring the PO corresponding to the PEI based on the DRX in response to not receiving the indication information.

In an example, monitoring the PO corresponding to the PEI includes:
monitoring all POs corresponding to the PEI before the PEI arrives at the next time or a paging message is received.

In an example, not monitoring the PO corresponding to the PEI includes:
not monitoring the PO corresponding to the PEI before the PEI arrives at the next time.

In an example, being unable to monitor the PEI includes at least one of the followings:
a PEI monitoring occasion colliding with other searching spaces;
the PEI monitoring occasion colliding with other physical downlink shared channels (PDSCHs);
missing the PEI monitoring occasion; or
failing to decode the PEI.

In an example, receiving the indication information sent by the network device includes at least one of the followings:
receiving the indication information through an RRC signaling; or
receiving the indication information through a system message.

In an example, the method further includes:
responding to the PO based on the indication information in the RRC signaling in response to receiving the indication information both through the RRC signaling and the system message.

According to a second aspect of the disclosure, a communication method is provided and applied to a network device, and includes:
sending indication information to UE, where the indication information is used for indicating a response behavior to a PO in a scenario where the UE in a non-connected state is unable to monitor a PEI.

In an example, sending the indication information to the UE includes:
sending the indication information to the UE through an RRC signaling; and/or
sending the indication information to the UE through a system message.

In an example, the response behavior to the PO includes:
monitoring all POs before the PEI arrives at the next time or a paging message is received; or
not monitoring the PO before the PEI arrives at the next time.

In an example, the scenario where the UE is unable to monitor the PEI includes at least one of the followings:
a PEI monitoring occasion colliding with other searching spaces;
the PEI monitoring occasion colliding with other physical downlink shared channels (PDSCHs);
missing the PEI monitoring occasion; or
failing to decode the PEI.

According to a third aspect of the disclosure, a communication apparatus is provided and applied to UE, and includes:
a monitoring unit, configured to monitor a PEI; and
a responding unit, configured to respond to a PO in response to the UE in a non-connected state being unable to monitor the PEI.

In an example, the apparatus further includes:
a receiving unit, configured to receive indication information sent by a network device, where the indication information is used for indicating a response behavior to the PO in a scenario where the PEI is unable to be monitored.

In an example, the response behavior to the PO in a scenario where the PEI is unable to be monitored includes:
monitoring the PO corresponding to the PEI based on a discontinuous reception (DRX) in response to the indication information indicating a first value.

In an example, the response behavior to the PO in a scenario where the PEI is unable to be monitored includes:
not monitoring the PO corresponding to the PEI in response to the indication information indicating a second value.

In an example, the response behavior to the PO in a scenario where the PEI is unable to be monitored includes:
monitoring the PO corresponding to the PEI based on the DRX in response to not receiving the indication information.

In an example, monitoring the PO corresponding to the PEI includes:
monitoring all POs corresponding to the PEI before the PEI arrives at the next time or a paging message is received.

In an example, not monitoring the PO corresponding to the PEI includes:
not monitoring the PO corresponding to the PEI before the PEI arrives at the next time.

In an example, being unable to monitor the PEI includes at least one of the followings:
a PEI monitoring occasion colliding with other searching spaces;
the PEI monitoring occasion colliding with other physical downlink shared channels (PDSCHs);
missing the PEI monitoring occasion; and
failing to decode the PEI.

In an example, the receiving unit is further configured to:
receive the indication information through an RRC signaling; and/or
receive the indication information through a system message.

In an example, the responding unit is further configured to:
respond to the PO based on the indication information in the RRC signaling in response to receiving the indication information both through the RRC signaling and the system message.

According to a fourth aspect of the disclosure, a communication apparatus is provided and applied to a network device, and includes:
a sending unit, configured to send indication information to UE, where the indication information is used for indicating a response behavior to a PO in a scenario where the UE in a non-connected state is unable to monitor a PEI.

In an example, the sending unit is further configured to:
send the indication information to the UE through an RRC signaling; and/or
send the indication information to the UE through a system message.

In an example, the response behavior to the PO includes:
monitoring all POs before the PEI arrives at the next time or a paging message is received; or
not monitoring the PO before the PEI arrives at the next time.

In an example, the scenario where the UE is unable to monitor the PEI includes at least one of the followings:
a PEI monitoring occasion colliding with other searching spaces;
the PEI monitoring occasion colliding with other physical downlink shared channels (PDSCHs);
missing the PEI monitoring occasion; or
failing to decode the PEI.

According to a fifth aspect of the disclosure, a user equipment is provided, and includes a processor, a transceiver, a memory and an executable program stored on the memory and able to be run by the processor, and the processor, when runs the executable program, executes steps of the communication method described in the first aspect.

According to a sixth aspect of the disclosure, a network device is provided, and includes a processor, a transceiver, a memory and an executable program stored on the memory and able to be run by the processor, and the processor, when runs the executable program, executes steps of the communication method described in the second aspect.

According to a seventh aspect of the disclosure, a storage medium is provided, and stores an executable program, and the executable program, when executed by a processor, implements the steps of the communication method described in the first aspect or the second aspect.

The communication method and configuration, the user equipment, the network device and the storage medium of the examples of the disclosure set the indication information for the UE, so as to indicate how the UE may still monitor the PO without the PEI when the PEI conflicts with other resources, so that the UE may still respond to the paging message in a case of missing the PEI, and the UE may not miss paging initiated by the network for the UE. The examples of the disclosure solve the problem in which PEI resources may still respond to paging at a network side when occupied by other resources that have a higher priority, thus improving network service capabilities, ensuring a paging success rate of the UE, and improving user experience.

1. A communication method, performed by user equipment (UE), and comprising:
responding to a paging occasion (PO) in response to being unable to monitor a paging early indication (PEI), wherein the UE is in a non-connected state.

2. The communication method according to claim 1, further comprising:
receiving indication information sent by a network device, wherein the indication information is used for indicating a response behavior to the PO in a scenario where the PEI is unable to be monitored.

3. The communication method according to claim 2, wherein the response behavior to the PO in a scenario where the PEI is unable to be monitored comprises:
monitoring the PO corresponding to the PEI based on a discontinuous reception (DRX) in response to the indication information indicating a first value; or
not monitoring the PO corresponding to the PEI in response to the indication information indicating a second value.

4. (canceled)

5. The communication method according to claim 1, wherein responding to a paging occasion (PO) in response to being unable to monitor a paging early indication (PEI) comprises:
monitoring the PO corresponding to the PEI based on a DRX in response to being unable to monitor the PEI.

6. The communication method according to claim 5, wherein monitoring the PO corresponding to the PEI comprises:
monitoring all POs corresponding to the PEI before a next PEI monitoring occasion arrives or a paging message is received.

7. The communication method according to claim 2 wherein the response behavior to the PO in a scenario where the PEI is unable to be monitored comprises: not monitoring the PO corresponding to the PEI in response to the indication information indicating a second value, wherein not monitoring the PO corresponding to the PEI comprises:
not monitoring the PO corresponding to the PEI before a next PEI monitoring occasion arrives.

8. The communication method according to claim 1, wherein being unable to monitor the PEI comprises at least one of the following:
a PEI monitoring occasion colliding with other searching spaces;
the PEI monitoring occasion colliding with other physical downlink shared channels (PDSCHs);
missing the PEI monitoring occasion; or
failing to decode the PEI.

9. The communication method according to claim 2, wherein receiving the indication information sent by the network device comprises at least one of the following:
receiving the indication information through a radio resource control (RRC) signaling; or
receiving the indication information through a system message.

10. The communication method according to claim 9, further comprising:
responding to the PO based on the indication information in the RRC signaling when receiving the indication information both through the RRC signaling and the system message.

11. A communication method, performed by a network device, and comprising:
sending indication information to user equipment (UE), wherein the indication information is used for indicating a response behavior to a paging occasion (PO) in a scenario where the UE in a non-connected state is unable to monitor a paging early indication (PEI).

12. The communication method according to claim 11, wherein sending the indication information to the UE comprises at least one of the following:
sending the indication information to the UE through a radio resource control (RRC) signaling; or
sending the indication information to the UE through a system message.

13. The communication method according to claim 11, wherein the response behavior to the PO comprises:
monitoring all POs before a next PEI monitoring occasion arrives or a paging message is received; or
not monitoring the PO before a next PEI monitoring occasion arrives.

14. The communication method according to claim 13, wherein the scenario where the UE is unable to monitor the PEI comprises at least one of the following:
a PEI monitoring occasion colliding with other searching spaces;
the PEI monitoring occasion colliding with other physical downlink shared channels (PDSCHs);
missing the PEI monitoring occasion; or
failing to decode the PEI.

15-28. (canceled)

29. A user equipment (UE), comprising a processor, a transceiver, a memory and an executable program stored on the memory and able to be run by the processor, wherein in response to determining that the processor runs the executable program, the processor is configured to execute the following method:
responding to a paging occasion (PO) in response to being unable to monitor a paging early indication (PEI), wherein the UE is in a non-connected state.

30. A network device, comprising a processor, a transceiver, a memory and an executable program stored on the memory and able to be run by the processor, wherein in response to determining that the processor runs the executable program, the processor executes the communication method according to claim 11.

31. (canceled)

32. The communication method according to claim 2, wherein monitoring the PO corresponding to the PEI comprises:
monitoring all POs corresponding to the PEI before a next PEI monitoring occasion arrives or a paging message is received.

33. The communication method according to claim 12, wherein the response behavior to the PO comprises:
monitoring all POs before a next PEI monitoring occasion arrives or a paging message is received; or
not monitoring the PO before a next PEI monitoring occasion arrives.

34. The user equipment according to claim 29, wherein the processor is configured to execute the following method:
receiving indication information sent by a network device, wherein the indication information is used for indicating a response behavior to the PO in a scenario where the PEI is unable to be monitored.

35. The user equipment according to claim 34, wherein the response behavior to the PO in a scenario where the PEI is unable to be monitored comprises:
monitoring the PO corresponding to the PEI based on a discontinuous reception (DRX) in response to the indication information indicating a first value; or
not monitoring the PO corresponding to the PEI in response to the indication information indicating a second value.

36. The user equipment according to claim 29, wherein responding to a paging occasion (PO) in response to being unable to monitor a paging early indication (PEI) comprises:
monitoring the PO corresponding to the PEI based on a discontinuous reception (DRX) in response to being unable to monitor the PEI.
